(19) United States
(12) Patent Application Publication
(10) Pub. No.: US 2019/0161277 A1
(43) Pub. Date: May 30, 2019

(54) LOGISTICAL SYSTEM AND PROCESS

(71) Applicant: Nexyst 360, Inc., Willmar, MN (US)

(72) Inventor: Dennis Pap, Lynden, WA (US)

(73) Assignee: NEXYST 360. INC., Willmar, MN (US)

(21) Appl. No.: 16/192,873

(22) Filed: Nov. 16, 2018

Related U.S. Application Data
(60) Provisional application No. 62/627,302, filed on Feb. 7, 2018.
(60) Provisional application No. 62/587,892, filed on Nov. 17, 2017.

(51) Int. Cl. B65G 3/04; B65D 88/74; B65B 1/04; A23B 9/08; B65G 67/02

(52) U.S. Cl. CPC B65G 3/04; B65D 88/747; B65D 88/744; A23V 2002/00; A23B 9/08; B65G 67/02; B65B 1/04

(57) ABSTRACT

A method for handling bulk products may include placing harvested product into a container and facilitating shipment of the container with the harvested product to an end user of the harvested product without further handling of the harvested product. A container for receiving, drying, shipping, and tracking the products may also be provided.

### CROSS-REFERENCE TO RELATED APPLICATIONS

The present application claims priority to U.S. Provisional Application 62/587,892 entitled Logistical System and Process which was filed on Nov. 17, 2017 and U.S. Provisional Application 62/627,302 entitled Logistical System and Process which was filed on Feb. 7, 2018, the content of each of which is hereby incorporated by reference in its entirety.

### TECHNOLOGICAL FIELD

The present application relates generally to systems and methods for collection, storage, transportation or other logistical management of grain, peanuts, oilseeds, cotton or other bulk products as well as packaged fruits, other packaged products, or other goods. More particularly, the present application relates to containerized logistical management of goods. Still more particularly, the present application relates to using environmentally controlled containers to collect, store, and transport goods to improve traceability and to reduce material handling thereby limiting loss, damage, or other quantity or quality reduction between origin and destination.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Current systems and processes for collecting, storing, and transporting grain, loose goods, or other bulk products often suffer from several problems. Current bulk product handling is laborious, time consuming, and leads to, among other things, large losses of product and a mingling of product that limits the ability to track product. For example, when including the various options for product handling, a series of 39 loose product handling operations may be performed between the origin location of a product and its destination. For example, when bulk product such as corn is harvested, it may be handled as many as 39 times from the time it is on the stalk, to the time it arrives at a facility for use to manufacture food, to generate energy in the form of ethanol, or for other uses. Through the process of handling the corn 39 times a large percentage of the product may be lost or left behind. The corn may also be mingled with corn produced from other farms and, as such, the location from which the corn came may become unclear very quickly. That is, for example, when corn leaves the farm and is delivered to a co-op, it may be mixed with corn from surrounding farms and/or fields and the ability to recall, trace, or otherwise track where a particular portion of corn came from may quickly be difficult to determine. Still other problems associated with transportation inefficiencies and other issues have plagued the logistics of bulk product management for a long time.

### SUMMARY

The following presents a simplified summary of one or more embodiments of the present disclosure in order to provide a basic understanding of such embodiments. This summary is not an extensive overview of all contemplated embodiments, and is intended to neither identify key or critical elements of all embodiments, nor delineate the scope of any or all embodiments.

In one or more embodiments, a method for handling bulk products may include placing harvested product into a container and facilitating shipment of the container with the harvested product to an end user of the harvested product without further handling of the harvested product until the container reaches the end user. In one or more embodiments, the method may also include in situ drying of the harvested product in the container.

In one or more embodiments, a method for containerized shipping may include shipping a bulk product in a container from a first location to a second location and shipping packaged products in the container from the second location to a third location. In one or more embodiments, the third location may be the same as the first location and in other embodiments, the third location may be a different location. The method may also include shipping bulk product in the container from the third location to the second location and shipping packaged products in the container from the second location to the first location.

In one or more embodiments, a container for shipping may include a housing with a bottom, a lid arranged on a top portion of the housing, and a floor arranged within the housing and spaced away from the bottom. The container may also include a drying port configured for receiving drying air and allowing the drying air to pass below the floor, upward through the container and out the lid. In one or more embodiments, the floor may be an air permeable floor. In one or more embodiment, the lid may provide for an air tight seal.

In one or more embodiments, a method of distributing bulk products may include receiving a container loaded with bulk products, storing the container on a pad, shipping the container to an export facility, and performing each of the steps of the method without handling the bulk product. For example, where a farmer sells loaded to containers to a domestic distributor, the distributor may take the mentioned steps to get the product to an export facility.

In one or more embodiments, a method of shipping bulk products may include loading a sea-going vessel with a plurality of containers containing bulk products, traveling across a sea with the vessel, unloading the plurality of containers from the sea-going vessel, and performing each of the steps of the method without handling the grain-type products. For example, an exporter may take the mentioned steps to export the bulk product from one country to another.

In one or more embodiments, a method for handling bulk products may include receiving loose harvested product into a container, drying the loose harvested product in situ, storing the container, and shipping the container with the harvested product to an end user of the harvested product without further handling of the harvested product until the container reaches the end user. In one or more embodiments, the shipping process may include stacking containers to create a stack of two containers on a truck trailer and carrying or transporting the stack of containers over the road. Additionally or alternatively, the shipping process may include stacking containers to create a stack of three containers on a rail well car and carrying or transporting the stack of containers over the rails.

In one or more embodiments, a container for storage and shipping may include a housing with a bottom, a lid arranged on a top portion of the housing, and a floor arranged within the housing and spaced away from the bottom to allow moisture from product in the container to drain out of the product and through the floor. Additionally, the container may include an interior with smooth walls including smooth panels covering otherwise corrugated sidewalls. Additionally, the corrugated sidewalls may be insulated. Additionally, the lid may include a plurality of lid locks that also are configured for use to lift the lid. The container may also include lifting lugs that are accessible when the lid is in place and when the lid is removed.

While multiple embodiments are disclosed, still other embodiments of the present disclosure will become apparent to those skilled in the art from the following detailed description, which shows and describes illustrative embodiments of the invention. As will be realized, the various embodiments of the present disclosure are capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

FIG. 1 is a perspective view of a storage and shipping container, according to one or more embodiments.

FIG. 2A is an end view of a storage and shipping container like that of FIG. 1 and including an integrated cooling unit, according to one or more embodiments.

FIG. 2B is an end view of a storage and shipping container like that of FIG. 1 and including an external cooling unit, according to one or more embodiments.

FIG. 3 is a cross-sectional view through an upper corner of the storage and shipping container of FIG. 1 showing a locking channel for sealing and alignment, according to one or more embodiments.

FIG. 4 is a top view of a floor of the storage and shipping container of FIG. 1 showing a perforated floor, according to one or more embodiments.

FIG. 5A is a side view of a storage and shipping container like that of FIG. 1 and having a low profile, according to one or more embodiments.

FIG. 5B is a side view of a storage and shipping container like that of FIG. 1 and having a high profile, according to one or more embodiments.

FIG. 6A is an end view of the storage and shipping container of FIG. 5A, according to one or more embodiments.

FIG. 6B is an end view of the storage and shipping container of FIG. 5B, according to one or more embodiments.

FIG. 7 is a close-up view of the perforated floor, according to one or more embodiments.

FIG. 8 is a top view of the storage and shipping container of FIG. 1, according to one or more embodiments.

FIGS. 9A-9G include a top view, a long cross-section, a top cross-section, a short cross-section, a side elevation, a front elevation (doors open), and a front elevation (doors closed), respectively, according to one or more embodiments.

FIGS. 10A-10F include a top view, a long cross-section, a top cross-section, a short cross-section, a side elevation, and a front elevation, respectively, according to one or more embodiments.

FIG. 11 is flow diagram illustrating bulk product handling, according to one or more embodiments.

FIG. 12 is a flow diagram illustrating a drastic reduction in product handling, according to one or more embodiments.

FIG. 13 is a flow diagram illustrating a container travel path, according to one or more embodiments.

FIG. 14A depicts packaged goods.

FIG. 14B depicts a low container having packaged goods stored therein for shipping.

FIG. 14C depicts a high container having packaged goods stored therein for shipping.

FIG. 14D depicts the container of FIG. 14B or 14C on a truck for shipping.

FIG. 14E depicts the container of FIG. 14B or 14C on a truck for shipping.

FIG. 15A depicts packaged goods.

FIG. 15B depicts a low container having packaged goods stored therein for shipping, according to one or more embodiments.

FIG. 15C depicts a high container having packaged goods stored therein for shipping, according to one or more embodiments.

FIG. 15D depicts the container of FIG. 15B or 15C on a truck for shipping, according to one or more embodiments.

FIG. 15E depicts the container of FIG. 15B or 15C on a truck for shipping, according to one or more embodiments.

FIG. 16 is a circuit diagram illustrating outgoing and returning usage of a container, according to one or more embodiments.

FIG. 17 is a plan view of a shipping hub, according to one or more embodiments.

### DETAILED DESCRIPTION

The present application, in some embodiments, relates to logistical management of bulk products. In particular, the present application discusses a storage container for bulk products that allows grain or other bulk product to be placed in the container, dried, stored, and shipped, from its place of origin to its destination all in the same container. This container and method allow material handling to be drastically reduced as compared to current methods. This drastic reduction in material handling allows for a related reduction in losses and damage to the product between its place of origin and its destination. Still further advantages relate to tracking of goods back to their place of origin. Current paradigms and infrastructure for grain-related material handling or other bulk product handling and transport have made it difficult to consider or imagine alternative approaches. The system and method disclosed herein reflect a revolution in material handling and logistical management of goods. While the system has advantages associated with bulk products, the system also provides advantages when used for packing and shipping of packaged goods. The versatility of the system described herein allows for full circle usage creating efficiencies never before seen in the logistical management of goods.

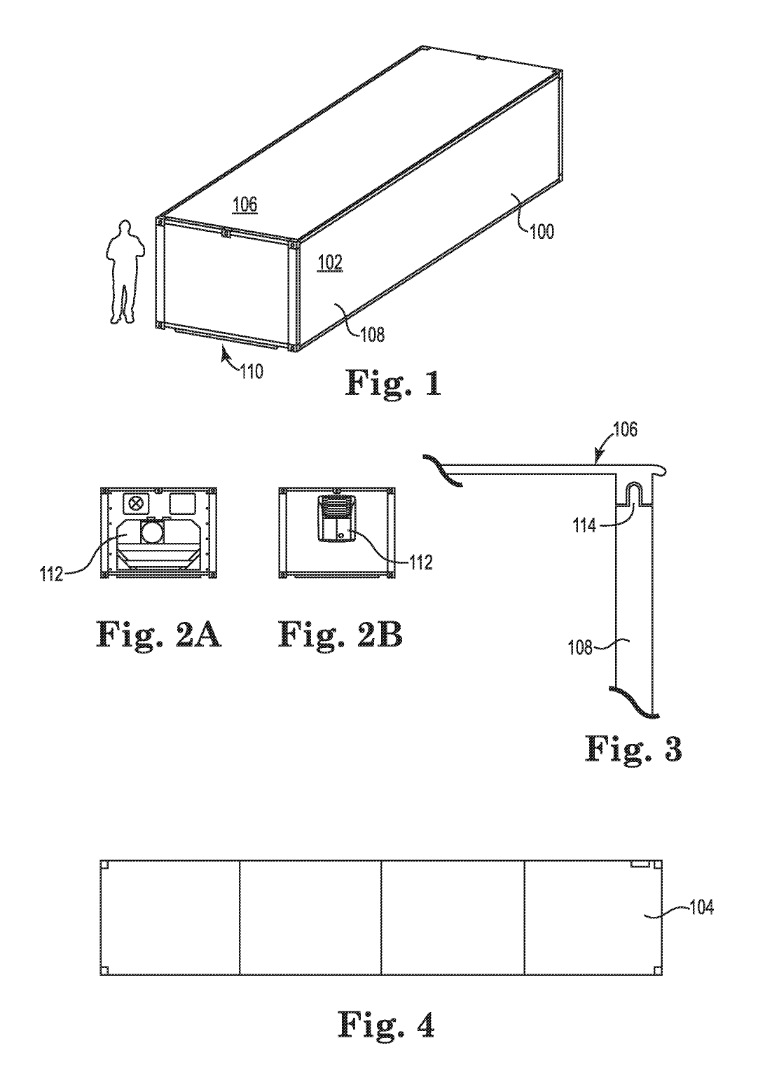

Referring to FIG. 1, the system may include a container 100 particularly adapted for storage of goods for a relatively long period of time and a particular versatility for goods. The container 100 may be configured to allow for environmental control and/or medium control allowing storage amidst particular gases for example. The container may include a housing 102, a floor 104, and a lid 106 or other access panel or portion.

The housing 102 may be configured to maintain the goods within the container 100 and to limit, reduce, restrict and/or control interaction with the exterior environment. The housing 102 may also be configured to support the goods stored therein during lifting, transporting, or other handling. The housing 102 may be substantially solid and may be constructed of steel, aluminum, metal alloys, molded materials, plastics, or other relatively durable materials. The housing may include sidewalls 108 and a bottom 110 and may be substantially rectangular in shape. In one more embodiments, the container may range from approximately 5′-8″ to approximately 6′-4″ high. The container may be approximately 8′-0″ wide by approximately 40′-0″ long. Still other dimensions and sizes may be provided and may be adjusted to accommodate shipping regulations and other design features. The housing 102 may be substantially or completely air tight preventing exchange of gas with the exterior environment except when desired such as, for example, during drying processes. In one or more embodiments, the housing may be insulated to reduce, minimize, and/or slow down temperature changes within the container. In one or more embodiments, insulation may be provided in conjunction with a cooling system and the insulation may function to maintain cool temperatures within the container.

As shown in FIGS. 2A and 2B, a cooling system 112 may be provided. The cooling system 112 may be configured to maintain the interior of the container in a cooled condition to slow down degradation and/or otherwise preserve the contents of the container. In one or more embodiments, the cooling system 112 may be integrated into the container as shown in FIG. 2A. In this embodiment, the cooling system 112 may be arranged within the boundaries of the container and may include inlets and outlets for receiving and exhausting air from outside of the container. The interior arrangement of the cooling system 112, may allow the container 100 to maintain its outside dimensions and, as such, may allow the container 100 to be loaded, stacked, and handled in a manner consistent with other containers 100. However, such interior arrangement of the cooling system 112 may reduce the volume available for goods within the container 100. In one or more other embodiments, the cooling system 112 may be arranged on an exterior surface of the container 100 as shown in FIG. 2B. In this embodiment, the cooling system 112 may be secured to an outside surface and may extend beyond the outer boundary of the container 100. Care may be taken to avoid damaging the cooling system 112 when handling this container. However, the external location of the cooling system 112 may allow for using the full interior volume of the container for goods. In one or more embodiments, the cooling system may be externally mounted, but may extend into the volume of the container and, as such, may be partially outside the container and partially inside the container.

FIG. 3 is a cross-sectional view of a lid 106 of the container of FIG. 1 as it engages the sidewall 108 of the container 100. As shown, a locking channel and/or tongue-in-groove detail 114 may be provided at the intersection between the lid 106 and the sidewall 108. This detail may function to seal the lid 106 to the container 100, avoid intrusion of moisture, and align the top of the sidewall 108. As shown, the locking channel may be formed in a turned down portion of the lid 106, which may extend along the edge of the lid 106. The turned down portion of the lid may include a u-shaped channel extending upwardly into the turned down portion forming an inverted channel. The channel may have a width approximately ⅓ of the width of the turned down portion and sidewall thickness and a similar or slightly larger depth. Correspondingly, the upper edge of the sidewall 108 may include a tab, rib, or tongue particularly shaped to enter or otherwise engage the locking channel. The tongue may have a width similar to or slightly smaller than the width of the channel and may have a length similar or slightly shorter than the depth of the channel so as to smoothly enter the channel. In one or more embodiments, the outside face of the tongue may be spaced away from the channel wall to form a gap and, as such, resist wicking or capillary action from drawing water upward and around the tongue. The channel and tongue may be reversed such that the channel is on the sidewall 108 and the tongue is on the lid 106, but moisture may have a tendency to rest in the channel in this case. Weep holes or other moisture releasing feature may also be provided. In one or more embodiments, a resilient sealing material may be provided along the tip of the tongue, along the base of the channel or otherwise along the intersection of the lid and sidewalls/end walls. The locking channel may extend along all of the sides of the container and may allow for effective sealing of the lid to the sidewalls of the container. The locking engagement of the lid 106 to the sidewalls 108 may also provide lateral support to the top of the sidewalls 108 and may resist outward bowing of the sidewalls 108 induced by outward pressure of the contents of the container. In one or more embodiments, cross-members may be provided such that lateral support to the tops of the walls is provided during loading and when, for example, the lid is not in position.

Referring now to FIG. 4, a perforated floor 104 may be provided within the housing 102 and may be configured to support the goods within the housing 102 and spaced apart from the bottom of the container 100. This feature may be particularly advantageous for purposes of drying efforts by creating a gap or space between the floor 104 and the bottom wall of the housing 102, for example. The floor 104 may include a perforated or other gas permeable system allowing gases from below the floor 104 to permeate or otherwise travel upward through the floor 104 and through the product. The container may be used in conjunction with a dryer that may actively circulate air into the space below the floor and upward through the floor and through the grain or other bulk goods within the container to vents in the lid or out the top of an uncovered container, for example. In one or more embodiments, the floor may be omitted where, for example, resting the goods on the bottom of the housing 102 is suitable for storage and shipping of the goods.

In one or more embodiments, the drying process may include a radio frequency dryer that does not rely on circulating hot air to dry the product in the container 100. In this embodiment, the perforated floor 104 may be provided as with the hot air drying process, but the perforated floor may be positioned closer to the bottom of the container 100 due to avoiding a need for larger volumes of hot air flow below it. The perforated floor, in this embodiment, may allow moisture from the goods to travel downward through the goods and through the floor 104 such that moisture may be collected and/or discarded. The perforated floor 104 may maintain the goods near the bottom of the container 100 at a location above the collected liquid, but closer to the bottom of the container 100 than a system with a floor 104 adapted for hot air drying. In this radio frequency drying system, the vents in the lid may also be omitted or they may be included to allow for other uses related to filling the container with inert or other gases, or cooler air circulation, for example.

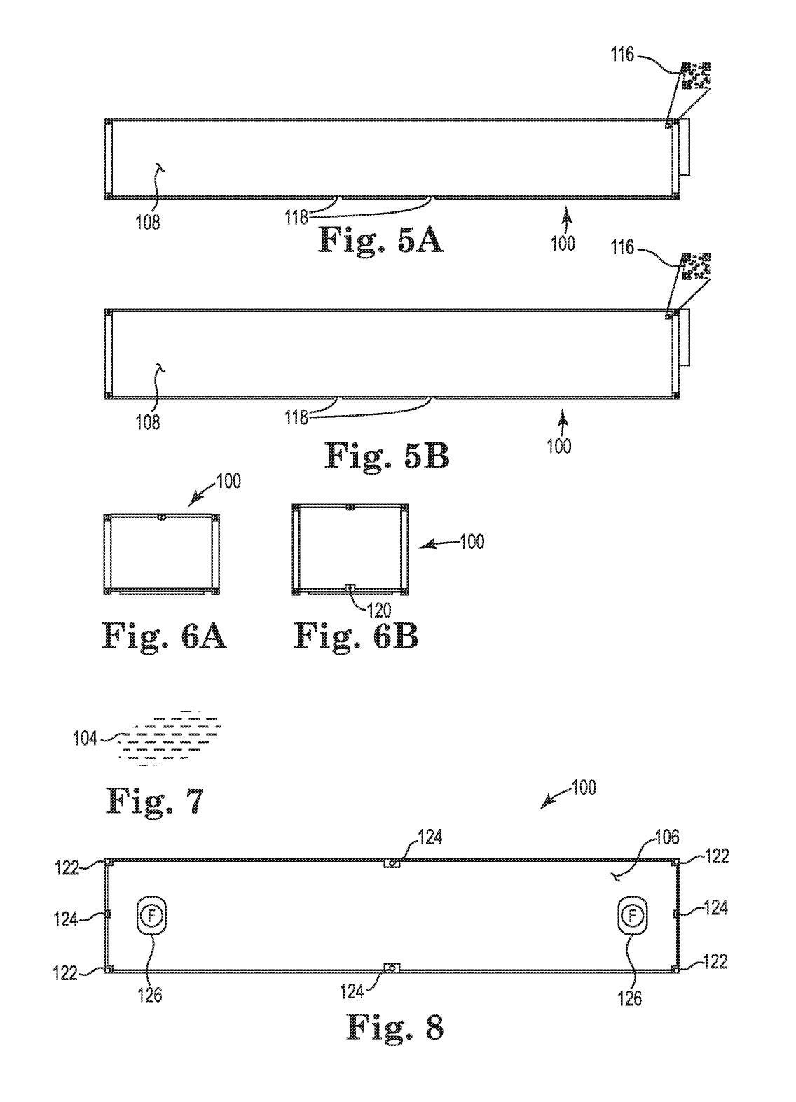

Turning now to FIGS. 5A and 5B, side views of storage and shipping containers 100 are shown. As shown, the containers 100 may include branding information as well as tracking information on them including a number and/or a bar code, QR code, or other unique identifier 116 for tracking and/or identifying the container 100 and/or its contents. This information may be provided on the sidewalls 108 as shown and/or on the end walls, top, or bottom as well. The containers may include forklift slots 118 extending laterally across the container on an underside thereof for receiving forks of a forklift and allowing the container to be picked up and carried for purposes of loading and management. Forklift slots 118 may be provided on the ends of the container as well.

The FIGS. 6A and 6B show end views of FIGS. 5A and 5B, respectively. As shown in FIGS. 6A and 6B and the container 100 may include a vented floor arranged slightly above the bottom of the container. On the end of the container, an access or vent door 120 may be provided that corresponds to the space below the floor. For example, the door may be approximately 7′ long side to side and may be approximately 4″ to 6″ in height allowing the door to opened and allowing gas, dry air, or other fluids to be pumped into the container below the floor. The door may be selectively closed and opened and may be secured with a twist lock, for example. FIG. 7 shows a close-up view of the slot-vented floor 104 that may allow for gases below the floor to migrate or flow upward through the floor and through bulk goods such as grain, for example.

A top view is shown in FIG. 8. Generally, the lid 106 may include one or more panels arranged on a top of the container configured for opening and allowing access to the goods in the container. It is to be appreciated that the lid 106 may be provided on other sides of the container, but that a top opening lid maybe advantageous for grain or other bulk product loading and handling, which may be placed in the container via a conveyor or chute, for example. The panels may include full width panels such that, when open, the full width of the space within the container is exposed and available for accessing and inserting or withdrawing goods. In one or more other embodiments, the panels may be smaller than the width of the container. In one or more embodiments, the one or more panels may have a length allowing for the full length of the container to be exposed or the one or more panels may be shorter than the overall length and may include portions at the ends of the container or between the panels that remain closed. The panels may be sealable panels having sealing devices or systems around the openings and allowing for the panels to be sealed to prevent infiltration and/or escape of gases, liquids, or debris into or from the container. In one or more embodiments, the panels may be designed or rated for particular pressure resistance such that internal positive or negative pressures may be maintained. The housing 102 may be constructed to withstand such pressure differentials as well by providing sufficiently thick walls and/or using fluted, corrugated, or other construction to strengthen the out of plane bending and or shear strength of the container housing portions. Still other access panels may be provided on the container on the sides, bottom, ends, or other locations. In one or more embodiments, the panel locations may include screens or other features allowing air to flow therethrough without escape of product and/or without infiltration of bugs, debris, or other items.

FIG. 8 shows a top view of the container including a series of opening/closing features and a series of handling features. For example, the four corners of the container may include vertical frame members 122 that may extend through the lid allowing the container to be picked up with the lid in position. Additionally, at an intermediate position along the length of the sidewalls and end walls or at other locations along the container, twist locks 124 or other lid clamps may be provided to secure the lid to the container. The twist locks may allow for the lid to be unlocked and lifted at the same time to avoid multiple touches to complete the processes. For example, a shackle or other device may be secured to the twist lock while it is also being unlocked and, as such, the lid may be ready to be lifted upon attachment of the shackle. The lid may be cut, sized, and adjusted to accommodate the frame members allowing for the container to be lifted when the lid is in position and when the lid has been removed. As also shown, the lid may include one or more vents 126 allowing air within the container to escape, particularly, during drying processes and, as such, carrying moisture out of the container. The escaping heated air may be used in a heat exchange process to assist with preheating air being used in the drying process and, as such, allow the heat escaping from the container to be reused for improving efficiency. The vents 126 may be one way vents and/or may be sealable such that the vents may be used to dry the goods in the container and then may be closed or otherwise sealed to maintain gases inside the container. The vent may be used to bleed off air or other gases in the container during filling of suitable storage gases such as, argon, for example.

The housing 102 may include an air, gas, or other fluid port on an end thereof. The fluid port may be accessible from the outside of the container and may allow for charging the container with gas and/or flowing gas, air, or other fluid through the container. In one or more embodiments, the fluid port may be arranged on an end of the container at or near the bottom of the container. The fluid port may be arranged below the floor and, as such, may be used to dry the product in the container by blowing, conveying, or otherwise forcing air or other gases into the container below the floor where the air or other gases may flow upward through the floor and the product so as to dry the product. The lid may be opened and/or other panels may be opened so as to allow the flow of air or gas. In one or more embodiments, particular panels may be opened to cause air or gas to flow through particular portions of the product in particular locations within the container, for example. Still other approaches to drying may be used including mixers or other devices to churn or mix the product and increase the speed of drying.

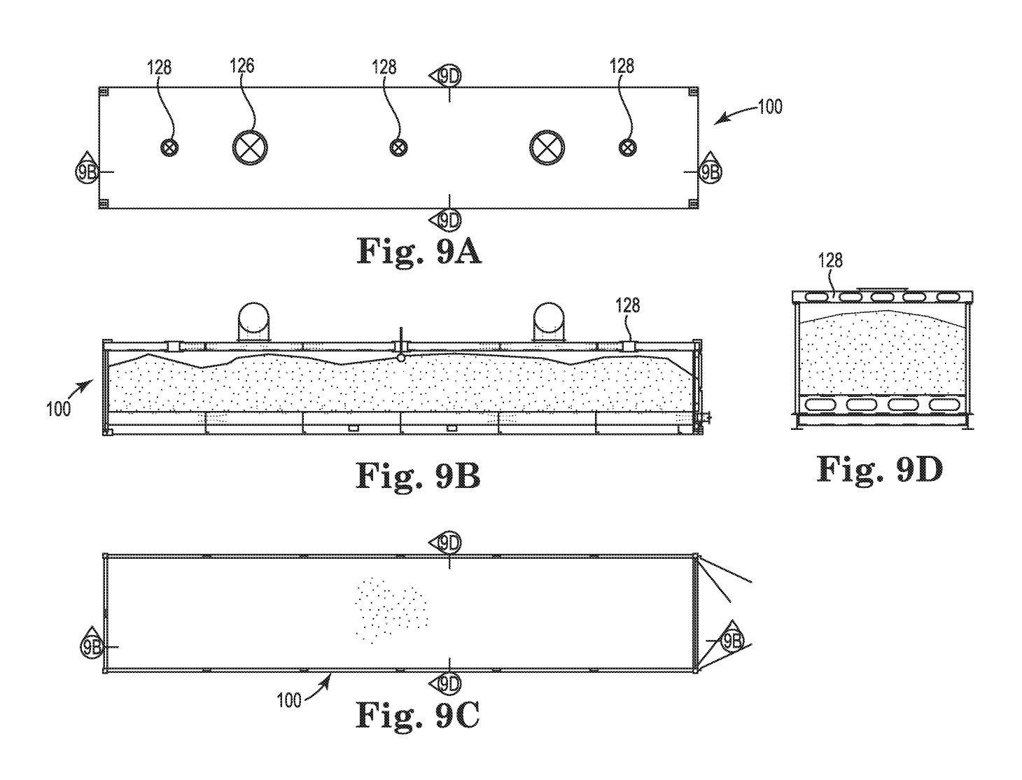

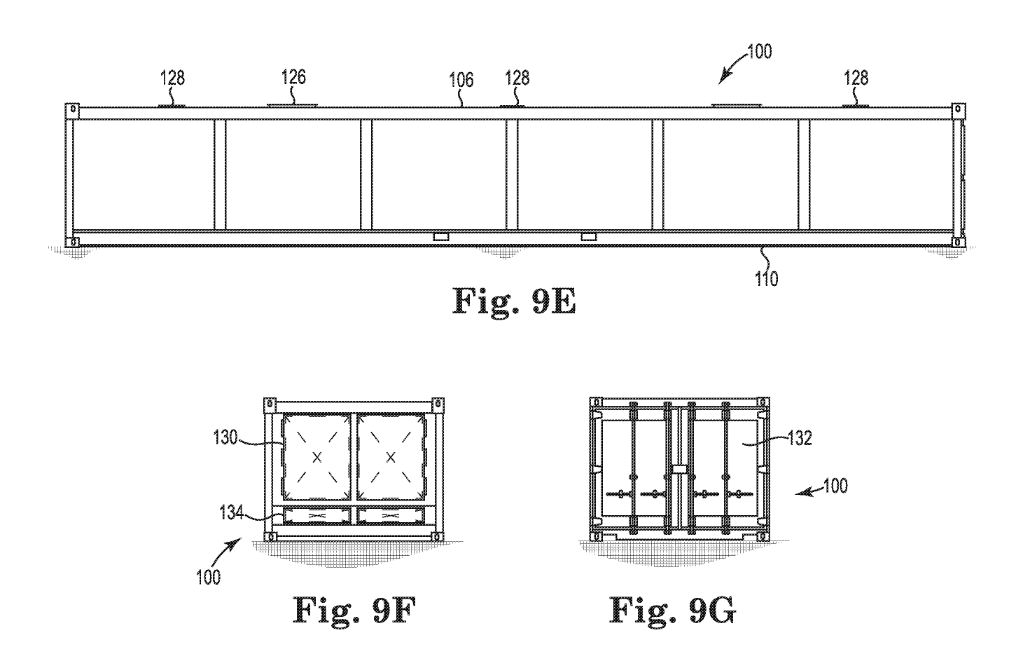

FIGS. 9A-9G include detailed engineering drawings of a container, according to one or more embodiments. The container may be the same or similar to the embodiments previously described. In addition, as shown in FIG. 9A, the lid may include one or more clean in place (CIP) ports 128. The clean in place ports may allow for insertion of a clean in place system shown, for example in FIG. 9B, where a nozzle or other equipment may be inserted into the container allowing the container to be cleaned without removing the lid.

As shown in FIG. 9D, the lid 106 may be reinforced with a series of channels 128 or other cross-members. Still further, as shown in FIGS. 9B, 9C, and 9D, the interior of the container may include a smooth interior wall covering that extends over an otherwise corrugated wall structure, for example. The smooth interior wall may allow for discharge of free flow of bulk goods and may also allow for insulation of the wall system.

As shown in FIG. 9C, the end of the container may include a pair of interior dump/inspection doors 130 and a pair of exterior doors 132. As shown by a comparison of FIGS. 9F and 9G, the pair of exterior doors 132 may be closed and secured with cross members and a locking system as shown in FIG. 9G. When opened, the exterior doors 132 may reveal the interior dump/inspection doors 130 as shown in FIG. 9F. The dump/inspection doors 130 may be relatively smaller and may be located in the end wall above the perforated floor system. Below the dump/inspection doors and below the floor system, one, a pair, or more access openings 134 and/or panels may be provided to allow for air, dry air, heated air, gas, or other fluids to be pumped or conveyed into the space below the floor and into the container 100. While access openings 134 for air or other gases are shown only on the end, several different arrangements may be provided. For example, access openings may be provided on each end to reduce the distance the dry air has to travel to reach the goods within the container. In other embodiments, access panels may be provided on the sidewalls and/or on each sidewall and may be spaced along the length of the sidewall to further reduce the distance traveled by the drying air or the preserving air or gas. Still other arrangements of access panels may include placing them in the bottom of the container. Still other arrangements may be provided. In one or more embodiments, a balance may be struck between multiple entry points for efficient drying operations and fewer entry points for maintaining product integrity.

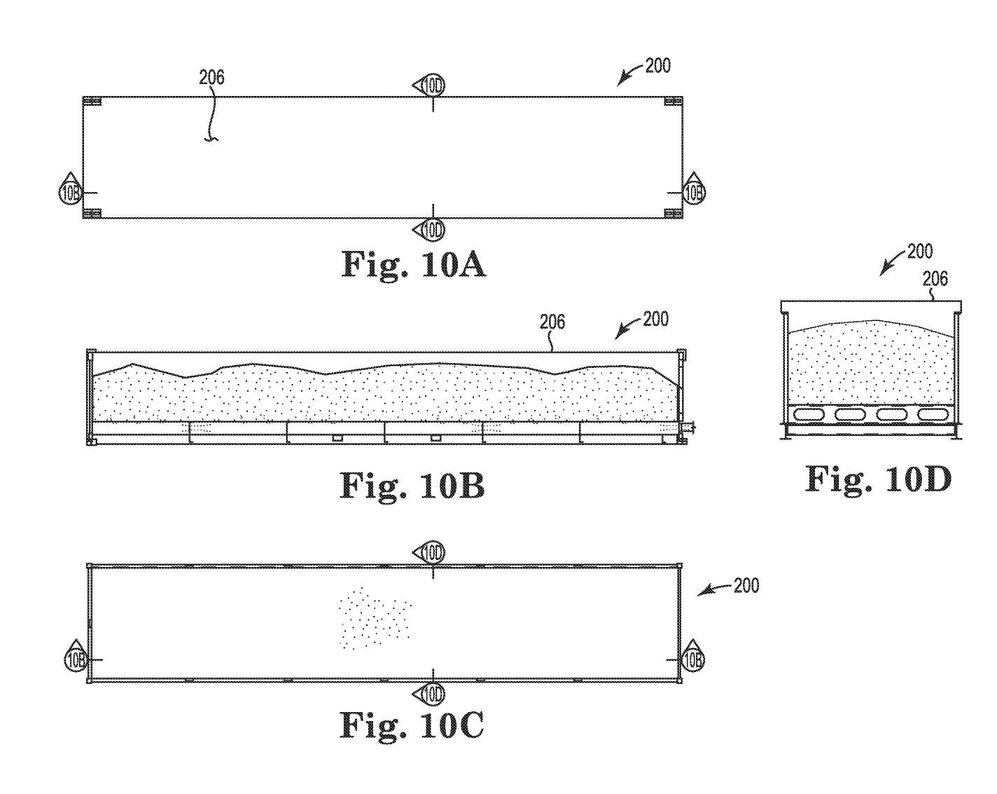

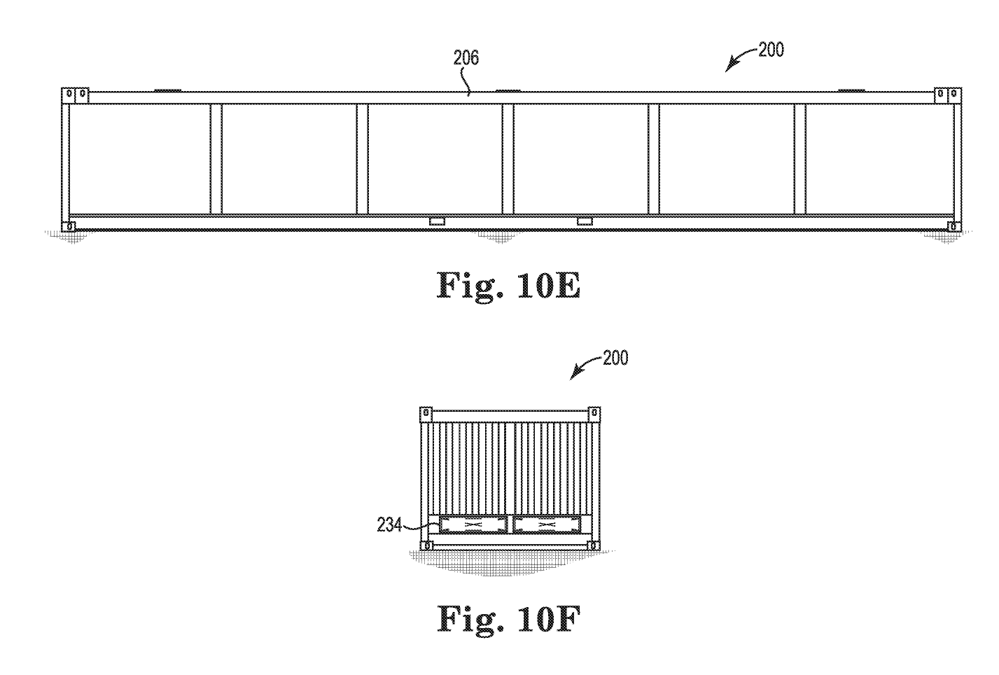

FIGS. 10A-10F include detailed engineering drawings of a container 200, according to one or more embodiments. In this embodiment, the lid 206 might not include the supporting rafters or cross members and the end of the container may not have exterior doors or dump/inspection doors. Rather, the container 200 may be configured for top loading and removal of goods. The end wall of the unit may include access panels 234 for accessing the space below the perforated floor and/or for conveying air, dry air, gases, and the like into the container 200.

In one or more embodiments, the container 100/200 may include a chiller, cooler, or other temperature control system. The system may be similar to the refrigeration and/or freezing systems that are present on trucks or containers.

It is to be appreciated that a comparison of the FIGS. 9A-9G with FIGS. 10A-10F shows that the container 100 in FIGS. 9A-9G includes vents, an inner smooth wall, a structurally reinforced lid, and an inner door on the end walls. The container 200 of FIGS. 10A-10F, for example, do not include these features. However, the several features of the various embodiments shown herein may be selected and combined in particular ways to suit various needs and any given combination of features may give rise to particular advantages. Nothing in this disclosure should be construed to limit the ability of the applicant to select from the various available features.

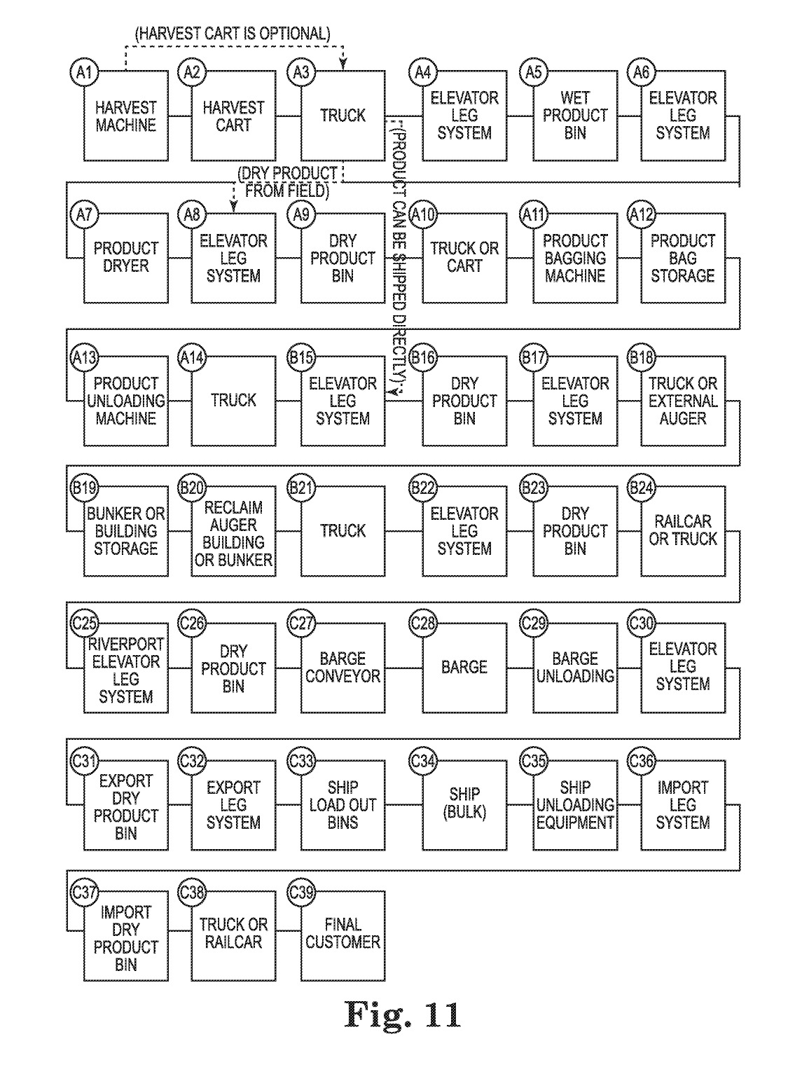

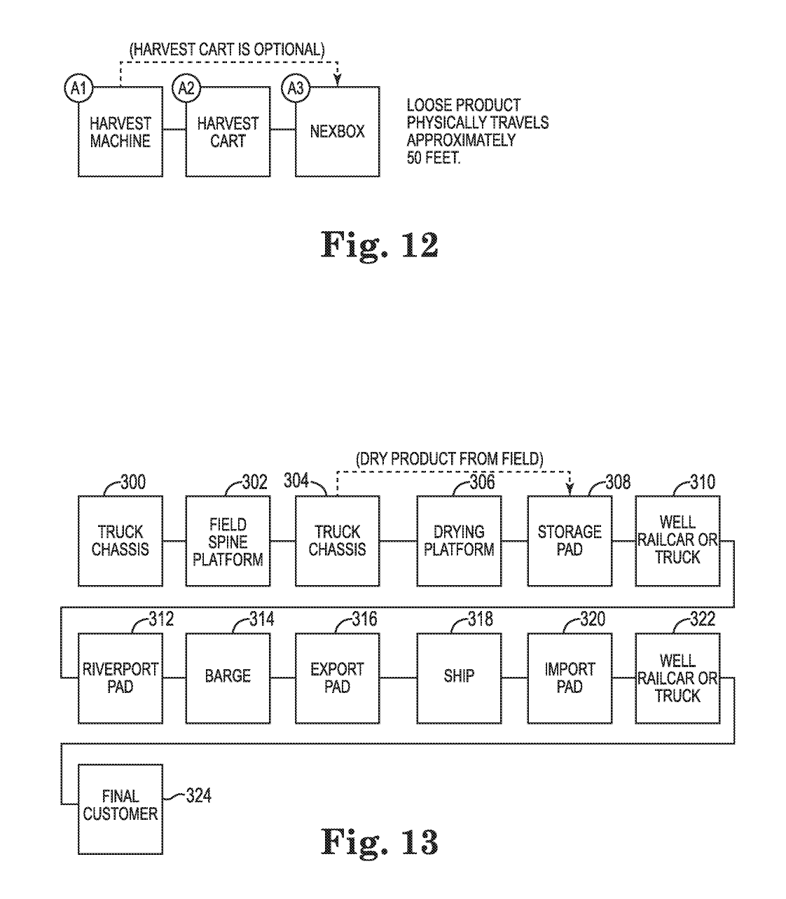

Turning now to FIG. 11, current bulk product handling is laborious, time consuming, and leads to, among other things, large losses of product and a mingling of product that limits the ability to track product. As shown in FIG. 11, when including the various options for product handling, a series of 39 loose product handling operations may be performed between the origin location of a product and its destination. In contrast, as shown in FIG. 12, these loose product handling operations may be reduced to as low as two handling operations.

### Harvest

With continued reference to FIG. 11, step Al includes the harvesting process where product is harvested through various harvest machines particular to each crop. For example, in the case of corn, a combine may be used to harvest the crop and collect the corn. Step A2 may be included to allow for the harvest machines to continue to harvest most of the time. That is, a harvest cart may meet the harvest machines anywhere in the field and, in some cases the harvest cart may be pulled alongside the harvest machine to collect the product. Sufficient harvest carts may be provided such that a harvest cart is always available such that the harvest machine can continually operate and unload the product from the harvest machines into the harvest carts. At A3, the harvest carts may be pulled to a wagon, truck or some form of transportation that will be driven down the road from the field with the harvested product. In one or more embodiments, the harvest machine may operate without harvest carts and may, instead, unload directly into the wagon, truck or other form of transportation. However, if the wagon or truck cannot meet the harvest machine at its location in the field and if the wagon or truck does not move with the harvest machine as it harvests crops, then downtime may occur to unload the harvest machine. Either, the harvest machine will have to stop harvesting and drive to the location of the wagon or truck and unload or it may have to stop where it is an unload.

### Drying and Storage

At A4, the wagon or truck may unload the product into a dump pit and elevator leg system or auger that will elevate, carry, or convey the product to the next step. At A5 and for product that is too wet to store at harvest moisture levels (product would deteriorate without drying), the product may be unloaded into a wet product bin. On the other hand, if the product is not too wet, the product can remain in a storage bin that is equipped with a false floor with perforated slots. A fan on the storage bin may push, blow, or otherwise circulate unheated (normal) air through the false floor, through the perforated slots, up through the bin and exhausted through vents at the top of the storage bin. This method may allow for drying of product when moisture to be removed from the product is at or about 1% to 2%. In the case of product wetter than the 1-2% mentioned, at A6, the wet product may go through an elevator leg system or auger again to be brought to a product dryer. At A7, the product may be dried in a dryer. There are various product dryers used in the industries including batch dryers and continuous flow dryers. Batch dryers may be filled to their capacity, the product may be dried, and then all the product may be unloaded at the same time and then a new batch of wet product may be unloaded into the batch dryer. In contrast, a continuous flow dryer may continually have new wet product going into the top of the product dryer and dried product exiting the bottom of the product dryer. After drying, at A8, the dry product may go through an elevator leg system or auger again to be brought to a product storage bin. At A9, the dry product may be unloaded into a dry storage bin. Most of the product can be stored at this level. However, if there is not enough storage capacity at harvest time, which is the case almost every harvest season, other storage may be used. At A10, when there is insufficient storage at the farm gate, product may be unloaded from the storage bins of A9 and loaded into a truck, wagon or harvest cart to be brought to A11. At A11, product may be unloaded from truck/wagon into a product bagging machine or through another offsite auger and storage bin system. At A12, product is then put into product storage bags laying horizontally along the ground. At A13, when it is time to ship the product, the product may be unloaded from the product storage bags through a product unloading machine or an auger/leg system of an offsite product storage. At A14, the product may be unloaded into a truck, wagon or other form of road transportation. If the product gained too much moisture in the product storage bags, it will need to go through steps A4-A10 again before being shipped to a customer. In some cases, the product may be shipped F.O.B. the buyer, co-op or other destination.

### Buyer/Distributor

At B15, the product may be shipped to the next level or a customer of the farmer and may go through their auger or elevator leg system. Depending on the timing of product marketing by the farmer, storage capacity of the farmers operations or close proximity to rail, river and export customers/markets, the farmer may skip steps A4-A14 or may even skip all the way to step C25 or C30. This depends largely on the farmer's physical proximity to these facilities. However, a large majority of product typically goes through the “B” level steps. At the customer location and at B16, the product may be unloaded into a dry storage bin. If, instead of pre-drying the material before shipping to the customer, wet product is shipped directly from the farmer or farmer's field to the “B” entity then the “B” entity may dry the product similar to steps A5 through A9. At B17, if there is insufficient storage capacity at the ‘B’ entity, the product may be stored in a building or bunker at this level and, as such, the product will go through the elevator leg system again. Alternatively, and in some cases, the product may be directly unloaded into wagons, trucks or harvest carts from the bins out of side spouts in product bins. At B18, the product may be transported via a truck, wagon, harvest cart or auger system to a building or bunker and at B19, the product may be unloaded and stored in the building or bunker. In most cases, the product is covered by a plastic tarp or overhead roof/building to protect the product from weather, animals and theft.

At B20, when it is time to ship the product to the next customer, the product is reclaimed from the bunker and buildings through a reclaim auger or payloader. At B21, the product may be unloaded into a wagon, truck or harvest cart and at B22, the product may be unloaded into the dump pit and elevator leg system again. At B23, the product may be unloaded into the dry product bin and at, B24, the product may be unloaded into a truck or railcar for shipment through kinetic energy of side spouts in the dry product bins. In some cases, it may need to go through the elevator leg system again.

It is to be appreciated that the parties involved in the ‘B’ operations may include local co-ops, private distributors, or other entities. These parties may be entities that are manage the logistics of the goods between the farm, for example, and the overseas and/or waterway shipments. These entities may be intermediaries, separate from the farmer, and separate from the large international supply managers. In one or more embodiments, these shipments may be made F.O.B. the port or other area in control of the overseas shipping entity.

### Shipping

At C25, the product may be transported via road or rail to the next step and may go through that facility's elevator leg system. At C26, from the elevator leg system, the product may be stored in a dry product bin. At C27, for river shipments, the product may be transported through a barge conveyor. In some cases, it may go through the elevator leg system again before the barge conveyor. There are some shipments that will bypass steps C25-C28 depending on close proximity to river terminals and freight costs.

At C28, the product may be unloaded and transported via a barge down the river. At C29, the product may be unloaded via a clam shell or auger system from the barge and at C30, the product may be placed into the export dump pit and elevator leg system. At C31, the product may be unloaded into the dry product bin and at C32, the product may go through the export leg or conveyor system. The product may then be unloaded at C33 into ship load out bins. Some export terminals may not have the load out bins and may, instead, load directly from the conveyer system. At C34, the product is transported via bulk ships. At C35, the product may be unloaded via a clam shell or auger system from the ship. At C36, the product may be unloaded into the import facility dump pit and elevator leg system and at C37, the product may be unloaded into the dry product bin. At C38, the product may then be shipped via river, rail or road depending on import facility location and final markets through a barge, railcar or truck. Product may need to go through the elevator leg system again to reach these modes of transportation. At C39, the product finally reaches and is unloaded at the final customer. Through all these steps, product may be physically moved over 5,280′ or 1 mile as it is handled between the various bins, containers, or modes of transportation.

It is to be appreciated that the entities associated with the ‘C’ operations may be relatively large and/or international organizations that manage the overseas logistics and handling. In one or more embodiments, these entities may be companies such as Cargill, CHS, Bunge, ADM, and the like. These companies may deliver product to any of a number of customers including manufacturers needing raw materials, distributors, or other buyers. It is to be appreciated that while the entities involved in the various stages of logistics have been identified as farmers, co-ops/distributors, and international companies, each of these entities may overlap into the adjoining operations or logistics and/or may perform any one or all of the logistical operations. In some cases, these shipments may be made F.O.B. the destination or the country of destination.

In contrast to the above process (i.e., A1-C39) involving a substantially high number of material handling steps, the process involved using the container described above may reduce the material handling steps to a number as low as two. As shown in FIG. 12, step Al may be the same or similar to that of the FIG. 11 process where product is harvested through various harvest machines particular to each crop. Also, and like the process of FIG. 11, at A2, harvest carts may be used that can meet the harvest machines anywhere in the field and then the harvest machines can unload the product from the harvest machines into the harvest carts. At A3, the product may be unloaded into a drying, storing, and shipping container. As with the process of FIG. 11, in some circumstances, the harvest machine may skip handling step A2 and unload directly from the harvest machine to the drying, storing, and shipping container. Once in the drying, storing, and shipping container, loose handling of the product may be avoided until the container reaches the final customer. That is, as shown in FIG. 13, the container may go through a process of handling to arrive at the final customer, but the product may remain contained and enclosed in the container the entire time. Accordingly, in contrast to the 1 mile of handling occurring in the FIG. 11 process, the FIG. 12 process may include physical movement of the product that is only about 50′ and the number of loose product handling steps may be drastically reduced.

The presently disclosed container approach may provide for higher quality product with less product handles, better market access for local producers and businesses and closer customer relationships between producer and end user/customer. The process may allow for traceability of the product back to the field, farmers name, hybrid planted, date planted, product applied such as fertilizers or pesticides, harvest date, etc. Still other information that may be available relating to the product may include test weight, protein content, oil content, etc. Still further, growing environment information may be available such as weather patterns, growing conditions, soil moisture, soil type, average rainfall, and the like. Still other detailed and informative information regarding the bulk goods may be included.

In one or more embodiments, block chain technology may be implemented for managing the logistics of the containers described herein. For example, a digital ledger approach may be used for managing the transactions domestically, through customs, and outside of the U.S. The digital ledger may allow for more seamless transactions with less paperwork and a higher level of certainty associated with the transactions. In one or more embodiment, the digital ledger may include the tracking information for one or more of the containers described herein and, as such, may include highly detailed information about the bulk product in the container such as the wide variety of information mentioned above (i.e., quality information, hybrid, date planted, products applied, growing conditions, etc.). The use of block chain technology both for purposes of transactions but also for carrying detailed data associated with a bulk product may be a marked and improved departure from an industry or process formerly capable of much less information such as type of bulk product (i.e., corn, oilseed, etc.) and quantity. The improved ability for maintaining this information and maintaining the association of the information with the product may allow for certifications such as ISO 9001 and ISO 22006.

The process may also allow for highly mobile transportation, storage and preservation of product instead of multiple assets fixed in multiple locations and may decrease product inventory losses (less food waste). Less food miles to transport the product may provide for higher quality product and a safer transportation system. In addition to the increased transportation safety, the facilities safety is increased with no chance of product engulfment, auger engagement or facility explosions. With the ability to track the container, the theft risk is reduced dramatically. In the FIG. 11 process, inventory is difficult and tracking whether another person or group took some product from your storage is difficult to say the least. The traceability of the container will allow for tracking inventory and location of product, not to mention product traits, history, and other relevant parameters discussed above. The containers may be purchased by farmers and distributors as an asset to their business and the containers may differ from other grain processing assets because they may be moveable non-real property assets. Accordingly, there may be broader market access and liquidity of the containers as compared to assets fixed in one location and small market area when an owner decides to retire or sell a business. There may be large decreases in operational costs due to less handling of the product and large decreases of freight costs with the ability to ship first and then sell compared to most transactions today where you need to sell first and then ship. That is, as a result of having the container traveling with the product, the product is not without a storage facility and, as such, may be shipped to a staging or other area without the need for infrastructure in place to receive the product. Accordingly, without having a buyer willing to receive the product, the product can be shipped and be on its way or it may already have arrived at a nearby location before a buyer elects to purchase the product.

It is also to be appreciated that the container described above may be particularly advantageous for grain, loose product, or other bulk products because of its top loading capability. That is, common containers are designed for end-loading where a forklift, for example, may physically drive into the end of the container to load the container with palletized goods. Using these types of containers for grain or other bulk product is difficult at best and may result in an underfilled container, for example.

As mentioned, FIG. 13 shows a process of transporting the container to a final destination. In one or more embodiments, the container may be placed on a chassis or trailer and transported from a storage location or pad to the field (300). In one or more embodiments, two empty containers may be shipped to the field at the same time. The container may be loaded on the chassis or the container may be moved to a spine platform by or in the field (302). Once loaded, the container may be placed back on a chassis and brought back to the pad (304). In one or more embodiments, one full container may be shipped back to the pad.

At the pad, the container may be placed on a drying platform where hot air or other drying fluid can be distributed through the container to dry wet product (306). That is, the product may be dried in situ within the container at the pad location. If the product is dry enough at harvest time, the container may bypass the drying pad and be directly stored/stacked at the pad. The drying platform may have multiple containers organized around a dryer. The dryer may include attachment hoses extending from the dryer to each surrounding or nearby container allowing multiple containers to be dried simultaneously. A series of containers may be stacked and stored at the pad awaiting shipment.(300)

When it is time for shipment, a container may be placed on a trailer or chassis. In the case of rail shipping, three containers may be stacked on a rail car (310). In either case, the containers may be shipped to a river port and placed on a pad at the river port facility 312. The containers may then be placed on a barge for river shipments (e.g., around 42 containers per barge) (314). In one or more embodiments, this step may be skipped depending on close proximity to river markets and transportation costs. The container may be removed from the barge or other shipping system and placed on a pad at an export facility until it is placed on a ship for ocean shipments (316). The container may travel across oceans or seas (318) to and may be removed from the ship and placed on a pad at an import facility (320). The container may then be placed on a barge, rail car, and/or chassis (322) and sent to its final customer (324), where it may be offloaded and placed on a pad and/or stacked.

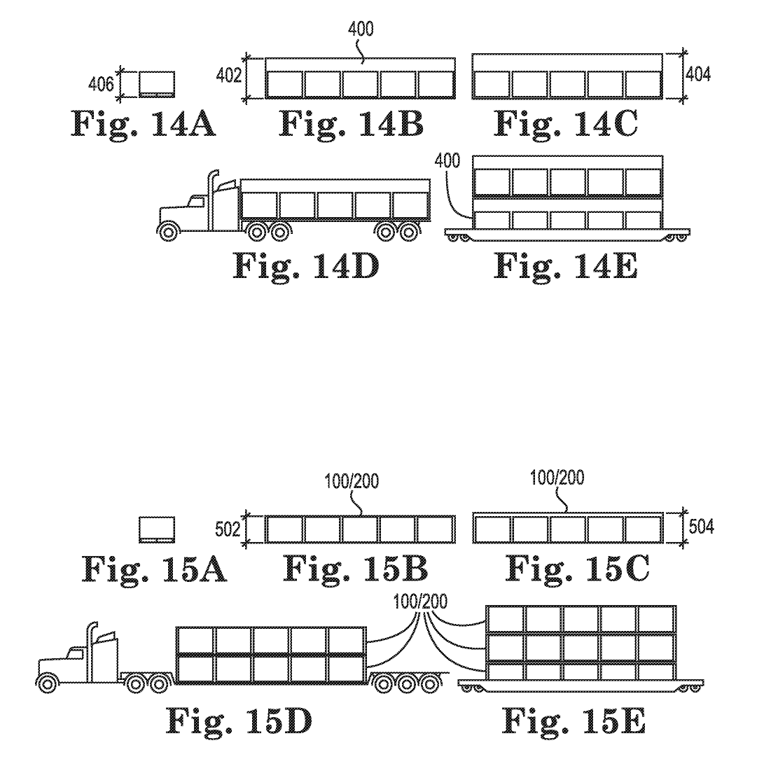

While the above discussion has been focused on bulk products, the container described above or similar containers may be used for packaged products and goods as well. For example, as shown in FIGS. 14A-E, packaged goods placed on pallets may be placed in containers 400 for shipment. Today's container sizes may include relatively standard dimensions of 8′-6″ in height 402 (low cube) or 9′-6″ in height 404 (high cube), 8′-0 in width and either 20′ or 40′ in length for ISO containers. Some domestic containers can be as long as 53′. Most packaged product packed on pallets range in height 406 of 4′2″ to 5′6″ on average. Accordingly, and as shown, much space is wasted in current packaged goods shipping. These particular containers are commonly designed to allow entry of a forklift from the end of the container to place the palletized goods and, as such, tend to be taller than the goods that are being shipped. That is, the pallets may be single stacked, leaving a relatively large amount of free space above the top of the goods within the container.

The intermodal containers can be shipped via road, rail, river or ocean and pallets can stay in containers until the container reaches its final customer or distribution center. Most of the time, they need to be shipped via road or truck first before they will reach a rail, river or ocean facility. As show in FIGS. 14D and 14E, the capacity of each mode of transportation is typically as follows:

Road—1 Per Truck

Rail—2 Per Well Car

River—Around 42 Per Barge

Ocean—Depending on Size of Ship—Can be 18,000 TEU's (20′ Equivalent Units/Containers) or More Now with Newer Ship Capacities

In contrast to current containerized shipment of packaged goods, the containers 100, 200 described herein may allow for a higher density of packaged goods to be shipped. Palletized packaged products may be put into a container through a top loading automated conveyor system. The container 100/200 may be shipped via road, rail, river or ocean and pallets may stay in the container until the container reaches its final customer or distribution center. Most of the time the containers may be shipped via road or truck first before they will reach a rail, river or ocean facility. In general, the containers described herein may be shorter in height than commonly used containers. Accordingly, as shown in FIGS. 15D and 15E, the capacity of each mode of transportation may be as follows:

Road—2 Per Truck (Assumes regulations allows 90,000#'s or more for 7 axle trucks) This will allow double the amount to be shipped via road compared to current system.

Rail—3 Per Rail Car—This will allow for 50% more to be shipped per rail car.

River—Around 42 Per Barge

Ocean—Depending on Size of Ship—Can be 18,000 TEU's (20′ Equivalent Units/Containers) or More now with Newer Ship Capacities

The container 100/200 described here may have the same standard dimensions of containers today except the height 502 may be 5′-8″ (low cube) or height 504 6′-4″ (high cube). As such, three of the containers may have the same height and inter-stack or ship the same as with 2 standard low or high cube containers today. Because most packaged products average in height from 4′-2″ to 5′-6″ on average today, the containers 100/200 herein may still be able to store and ship the same amount of product per container but may be able to ship 100% more product over the road or 50% more product over the rail.

For most modes of transportation for product today, packaged products are not shipped in bulk modes and conversely bulk products are not shipped in packaged container modes. As may be appreciated this creates large inefficiencies in shipping costs. Also, most of the bulk shipments out of the U.S. are traveling from East to West across the Pacific and packaged products are traveling from West to East across the Pacific. Due to the lack of interchangeability between container modes, this creates empty modes of transportation for the one-way return trip. This creates unnecessary freight costs, decreased efficiencies, higher energy consumption/costs, labor, repairs and infrastructure needed to support all the shipping and storage requirements.

It is to be appreciated that bulk, in the context of the present application, may include loose, unpackaged, products such as grain or other loosely handled products. Moreover, it should be appreciated that current infrastructure for managing bulk product is focused on handling loose product at each location and infrastructure has been created and constructed at these facilities for doing so. Moreover, current container designs do not lend themselves toward use with loose product because of their end-loading design as opposed to a top-loading design.

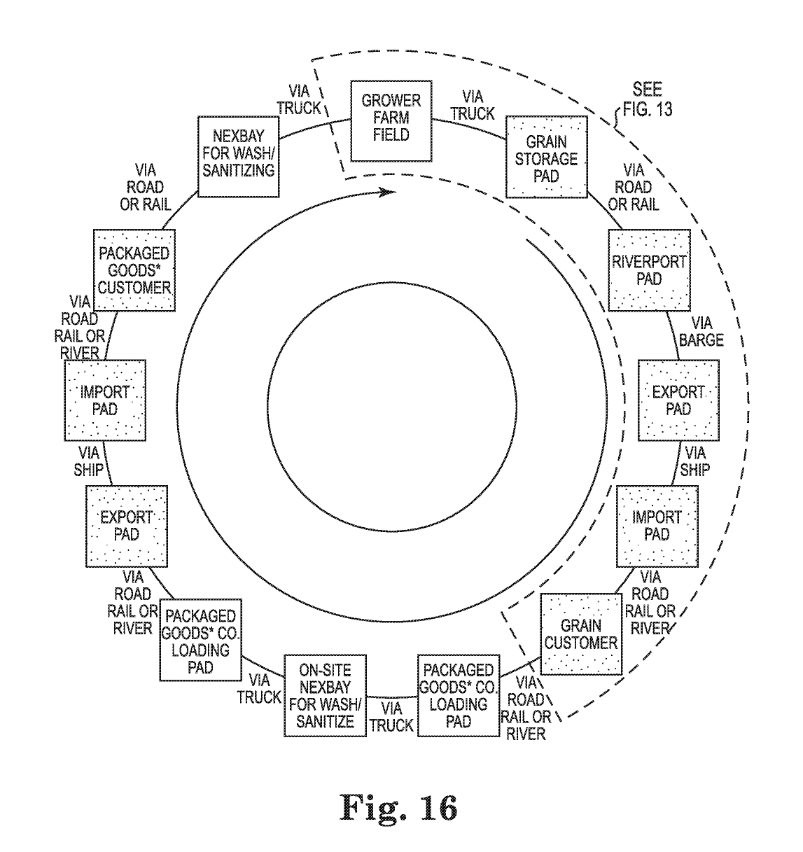

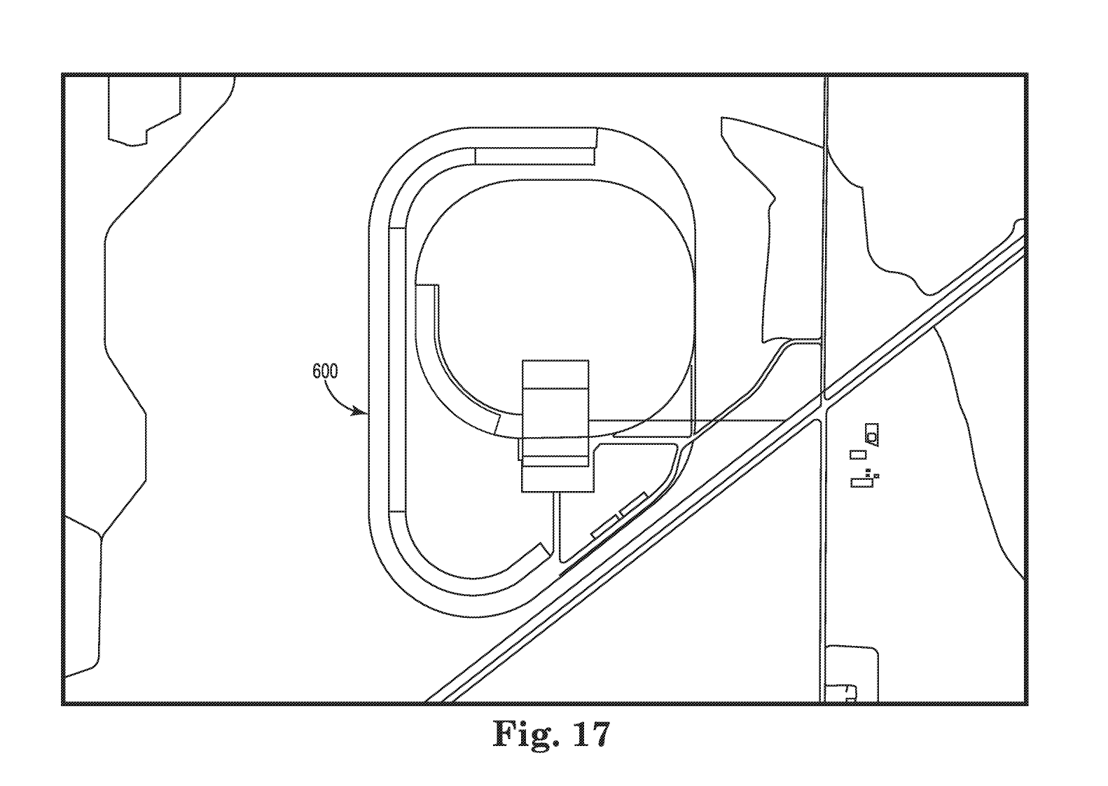

In one or more embodiments of the process described herein, and as shown in FIG. 16, the process may connect both the bulk and packaged product shipments together while removing many extra costs and in a dramatic more sustainable way in the described container. This creates a shipping continuum where bulk products are shipped West across the Pacific to a customer, unloaded, and reloaded with packaged products and shipped East across the Pacific back to its origin. This continuum circle model is a great solution to where our products (bulk or packaged) will be manufactured and where they need to get to tomorrow.

In one or more embodiments, for example, after the process of FIG. 13 is performed for shipping a bulk product from North America (Northern Hemisphere) bulk harvest time period to an Asian market, the container may be returned to a pad at an Asian packaged/palletized manufacturer. This manufacturer may load the pallets into the container and the reverse process of FIG. 13 may be performed. In one or more embodiments, the packaged/palletized products may first go to a South American market and then the container may be used for the South American (Southern Hemisphere) bulk harvest time period. The container may then be shipped back to Asian markets and then loaded again at an Asian manufacturer with packaged/palletized products going back to North America markets completing the continuum circle for a given year. In this manner, not only does the container go full circle in a loaded condition, it may also take advantage of opposing harvest seasons in conjunction with shipping times to allow for further efficient use of containerized shipping. While switching between bulk and packaged products is described, the container can also be used to ship bulk products both directions and/or packaged products both directions. For example, fertilizer type products may be shipped from Asian markets to the U.S. after grain-type products are shipped to an Asian market. Still other combinations of shipping products and types may be provided. For example, packaged cold or frozen goods such as meats may typically be produced relatively central to the U.S. while fruits and vegetables may be produced and/or imported near the coasts. Accordingly, the container system of the present application may be used to ship packaged meats to the coasts and return with fruits and vegetables, for example. The shipping efficiencies over the road and over rail may be particularly advantageous for these processes.

In still other embodiments, the above-described system may be used to perform a higher turn shipping process where, generally, the container may travel a shorter distance and repeat the process more often and/or faster. For example, with reference to FIG. 11, the present described container system may be used with otherwise conventional methods and systems of processing and shipping product, particularly bulk product. For example, the present described container system may be used starting, for example, as stage B23 of the process shown in FIG. 11. That is, some or all of the conventional methods of transporting bulk product to a rail car or other transportation system may be provided through stage B22, and then the product may be loaded into a container such as the ones described herein. That container may be shipped via rail car or truck to a barge, carried to via barge to a ship yard, and loaded onto to a ship for transport overseas, for example. The product may remain in the container until it reaches its final destination (i.e., C39) or it may be unloaded from the container at some intermediate point, such as at the ship yard (i.e., C30), for example. The efficiencies of the current described container likely make logistical sense and even when not used from the start to finish. That is, in particular, the number of containers that can be stacked for rail transportation and truck transportation create efficiencies of use for these shorter turn trips even if the containers are returned empty and not used for return of packaged good or other products.

Referring now to FIG. 17, a hub or station 600 for receiving and shipping containers of the present system is shown. As shown, a yard adjacent a railroad track or system is shown and includes roadway access for trucks as well. The hub may include a shop and/or maintenance building where maintenance on the containers, trailers, rail cars, or other equipment may be performed. The shop may also include dryers in the form of hot air or radio frequency dryers for drying grain or other bulk products in containers. For example, if the containers have recently come from a harvest location, on a truck for example, the truck may follow the roadway paths into the shop and deliver the container for connection to drying equipment. After drying, the container may be placed on rail cars and moved to a primary storage location outside the shop or it may be moved to a secondary storage location on the outer loop, for example. An inner rail loop may be provided for managing filled containers and for filling trains with product. One advantage of the current system is the ability to quickly manipulate the containers to load a train and, as such, load the train much faster than otherwise possible.

The primary storage location outside the hub may be used for transloading processes. For example, if a shipment of containers are returned to the facility having been shipped out with bulk product and returning with packaged goods, a transloading process may be used to remove the packaged goods from the containers and place them in trucks via the loading dock doors. Other transloading processes may also be performed.

The building or other locations at the hub may also be used for cleaning the containers. For example, the containers may be cleaned between periods of unloading and loading or when the containers are otherwise empty, for example.

The system as described herein may reduce, minimize, and or eliminate waiting, generally. For example, several containers may be provided to a harvest location such that the combine does not need to await arrival of a truck to have a place to unload grain. Moreover, trucks that may otherwise wait at a harvest location for an earlier truck to be filled, may not need to wait because the containers can be filled prior to requesting pick up by a truck. The issue of timing may be eliminated because of the readily available containers that are not tied to a transportation vehicle. Moreover, the loading and unloading of railcars may proceed much faster and may be facilitated by readily loaded and available containers that merely need to be placed on a rail car and secured. The presence of ship yards that are full of containers available for shipping reduces the need for ships to wait for containers to arrive.

Although the present invention has been described with reference to preferred embodiments, persons skilled in the art will recognize that changes may be made in form and detail without departing from the spirit and scope of the invention.

As used herein, the terms “substantially” or “generally” refer to the complete or nearly complete extent or degree of an action, characteristic, property, state, structure, item, or result. For example, an object that is “substantially” or “generally” enclosed would mean that the object is either completely enclosed or nearly completely enclosed. The exact allowable degree of deviation from absolute completeness may in some cases depend on the specific context. However, generally speaking, the nearness of completion will be so as to have generally the same overall result as if absolute and total completion were obtained. The use of “substantially” or “generally” is equally applicable when used in a negative connotation to refer to the complete or near complete lack of an action, characteristic, property, state, structure, item, or result. For example, an element, combination, embodiment, or composition that is “substantially free of” or “generally free of” an element may still actually contain such element as long as there is generally no significant effect thereof.

To aid the Patent Office and any readers of any patent issued on this application in interpreting the claims appended hereto, applicants wish to note that they do not intend any of the appended claims or claim elements to invoke 35 U.S.C. § 112(f) unless the words “means for” or “step for” are explicitly used in the particular claim.

In the foregoing description various embodiments of the present disclosure have been presented for the purpose of illustration and description. They are not intended to be exhaustive or to limit the invention to the precise form disclosed. Obvious modifications or variations are possible in light of the above teachings. The various embodiments were chosen and described to provide the best illustration of the principals of the disclosure and their practical application, and to enable one of ordinary skill in the art to utilize the various embodiments with various modifications as are suited to the particular use contemplated. All such modifications and variations are within the scope of the present disclosure as determined by the appended claims when interpreted in accordance with the breadth they are fairly, legally, and equitably entitled.

What is claimed is:

1. A method of distributing bulk products, comprising:
receiving a container loaded with bulk products or receiving loose harvested product into a container;
storing the container on a pad;
shipping the container to an export facility; and
performing each of the steps of the method without handling the bulk product.

2. The method of claim 1, further comprising drying the loose harvested product in situ.

3. The method of claim 1, further comprising shipping the container with the harvested product to an end user of the harvested product without further handling of the harvested product until the container reaches the end user.

4. The method of claim 1, wherein shipping the container comprises:
stacking containers to create a stack of two containers on a truck trailer; and
carrying the stack of containers over the road.

5. The method of claim 1, wherein shipping the container comprises:
stacking containers to create stack of three containers on a rail well car; and
carrying the stack of containers over the rails.

6. The method of claim 1, further comprising:
loading a sea-going vessel with a plurality of containers containing bulk products;
traveling across a sea with the vessel;
unloading the plurality of containers from the sea-going vessel; and
performing each of the steps of the method without handling the grain-type products.

7. The method of claim 1, further comprising maintaining product information associated with the container.

8. The method of claim 7, wherein the product information comprises hybrid information of the bulk product.

9. The method of claim 8, wherein the product information comprises growing conditions of the bulk product.

10. The method of claim 9, wherein the growing conditions include one of herbicide applications, pesticide applications, weather patterns, soil type, and soil moisture content.

11. The method of claim 7, wherein the product information comprises protein content.

12. The method of claim 1, further comprising utilizing a digital ledger system for managing transactions.

13. The method of claim 12, further comprising utilizing a digital ledger system for maintaining product information in associated with the container.

14. A method for handling bulk products, comprising:
placing harvested product into a container;
facilitating shipment of the container with the harvested product to an end user of the harvested product without further handling of the harvested product until the container reaches the end user.

15. The method of claim 14, further comprising in situ drying of the harvested product in the container.

16. The method of claim 14, further comprising shipping the container from a first location with the harvested product to a second location and shipping the container from the second location to a third location with packaged goods.

17. The method of claim 16, wherein the third location is the same as the first location.

18. The method of claim 16, further comprising shipping the container from the third location to the second location with bulk goods and shipping the container from the second location to the first location with packaged goods.

19. A container for storage and shipping, comprising:
a housing with a bottom;
a lid arranged on a top portion of the housing; and
a floor arranged within the housing and spaced away from the bottom to allow moisture from product in the container to drain out of the product and through the floor.

20. The container of claim 19, wherein the interior of the container includes smooth walls including smooth panels covering otherwise corrugated sidewalls.

21. The container of claim 20, wherein the corrugated sidewalls are insulated.

22. The container of claim 20, wherein the lid comprises a plurality of lid locks that also are configured for use to lift the lid.

23. The container of claim 20, wherein the container comprises lifting lugs that are accessible when the lid is in place and when the lid is removed.

24. The container of claim 19, wherein the floor is an air permeable floor.

25. The container of claim 19, wherein the lid comprises and air tight seal.
